(19) United States
(12) Patent Application Publication
(10) Pub. No.: US 2008/0174211 A1
(43) Pub. Date: Jul. 24, 2008

(54) MOTIVE FORCE GENERATING DEVICE

(75) Inventor: Yu-Ming LIU, Taichung City (TW)

Correspondence Address: BENESCH, FRIEDLANDER, COPLAN & ARONOFF LLP;ATTN: IP DEPARTMENT DOCKET CLERK, 2300 BP TOWER, 200 PUBLIC SQUARE, CLEVELAND, OH, 44114, US

(73) Assignee: Te-En Liu, Taichung City (TW)

(21) Appl. No.: 11/625,932

(22) Filed: Jan. 23, 2007

(51) Int. Cl. H02K 7/14; H02K 11/00; H02K 21/12

(52) U.S. Cl. 310/67 R; 310/68 B; 310/156.05

(57) ABSTRACT

A motive force generating device includes a rotating member, a driving magnet unit, a driven magnet unit, and a sensor unit. The driving magnet unit is disposed at a position relative to the rotating member. The driven magnet unit is mounted on and is co-rotatable with the rotating member. The driving magnet unit is alternately enabled and disabled by the sensor unit so as to cause rotation of the rotating member.

### BACKGROUND OF THE INVENTION

1. Field of the Invention

This invention relates to a motive force generating device, more particularly to a motive force generating device that generates a motive force using electrical energy.

2. Description of the Related Art

A conventional motive force generating device involves the use of fuel, which is relatively expensive. It has been proposed heretofore to use electric motors. While numerous electric motors of a conventional type have been proposed in the art, there is a need in the art to improve energy efficiency of motive force generating devices, particularly those used in motor vehicles.

### SUMMARY OF THE INVENTION

According to the present invention, a motive force generating device comprises a rotating member, a driving magnet unit, a driven magnet unit, and a sensor unit. The rotating member is rotatable about an axis of rotation. The driving magnet unit is disposed at a position relative to the rotating member. The driven magnet unit is mounted on and is co-rotatable with the rotating member. The sensor unit causes one of the driving and driven magnet units to generate a magnetic field when the rotating member is at a first angular orientation relative to the driving magnet unit such that the driving and driven magnet units generate magnetic forces for causing rotation of the rotating member, and disabling said one of the driving and driven magnet units from generating the magnetic field when the rotating member is at a second angular orientation relative to the driving magnet unit, thereby permitting further rotation of the rotating member to the first angular orientation by virtue of inertia.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic partly cutaway view of the preferred embodiment of a motive force generating device according to this invention;

FIG. 2 is partly sectional view of the preferred embodiment taken along line X-X of FIG. 1; and

FIG. 3 is a schematic partly cutaway view illustrating a state where a rotating member is at an angular orientation relative to a driving magnet unit.

### DETAILED DESCRIPTION OF THE PREFERRED EMBODIMENT

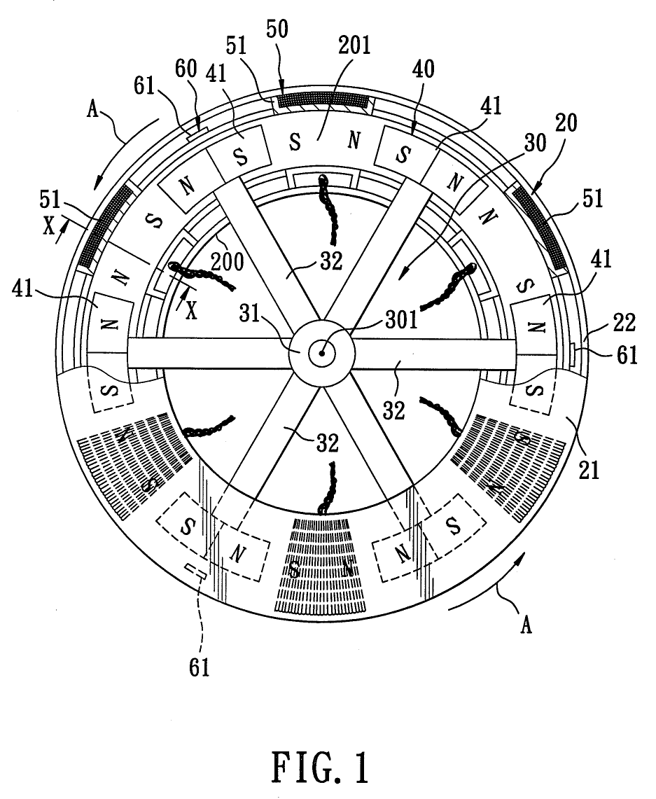

Referring to FIG. 1, the preferred embodiment of a motive force generating device according to this invention is shown to include an annular housing 20, a rotating member 30, a driving magnet unit 50, a driven magnet unit 40, and a sensor unit 60.

The annular housing 20 includes complementary upper and lower housing parts 21, 22.

The rotating member 30 extends into the annular housing 20, and is rotatable relative to the annular housing 20 about an axis of rotation 301, which is at the center of the annular housing 20. In particular, the upper and lower housing parts 21, 22 of the annular housing 20 cooperatively define an accommodating space 201. The annular housing 20 is formed with a hole 200 that surrounds the axis of rotation 301 and that is in spatial communication with the accommodating space 201. The rotating member 30 includes a hub 31, and six angularly displaced spokes 32, each of which extends radially and outwardly from the hub 31 and into the accommodating space 201 through the hole 200. In this embodiment, the rotating member 30 is rotatable relative to the driving magnet unit 50 between first and second angular orientations.

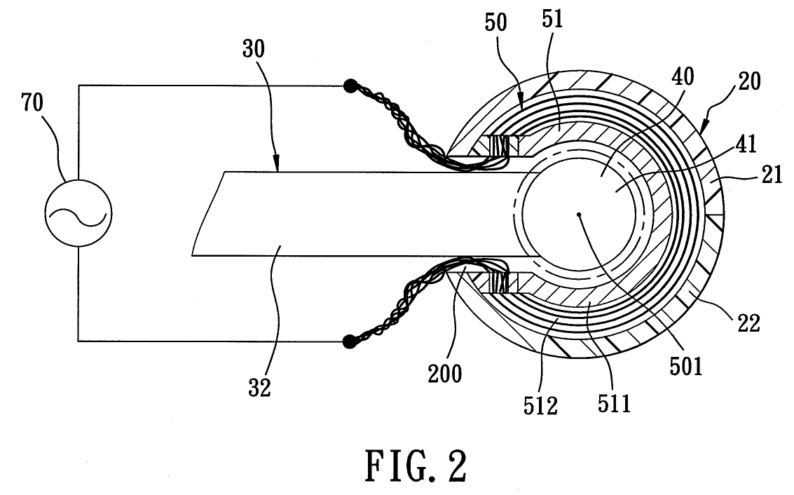

With further reference to FIG. 2, the driving magnet unit 50 is disposed in the accommodating space 201 in the annular housing 20 at a position relative to the rotating member 30, is mounted on the annular housing 20, and includes six angularly spaced apart electromagnets 51, each of which includes a core 511 that has a core axis 501 lying on a plane transverse to the axis of rotation 301, and a wire 512 that is wound on the core 511. In this embodiment, the wire 512 of each of the electromagnets 51 of the driving magnet unit 50 has opposite ends that are disposed externally of the annular housing 20 and that are coupled to an electric power source 70.

The driven magnet unit 40 is disposed in the accommodating space 201 in the housing 20, is mounted on and is co-rotatable with the rotating member 30, and includes six angularly spaced apart magnets 41, each of which is mounted on a free end of a respective one of the spokes 32 of the rotating member 30. In this embodiment, each of the magnets 41 of the driven magnet unit 40 is a permanent magnet.

It is noted that the magnets 41 of the driven magnet unit 40 are arranged such that adjacent poles of two adjacent ones of the magnets 41 have the same polarity.

The sensor unit 60 includes three angularly spaced apart sensors 61, each of which is disposed between a respective one of adjacent pairs of the magnets 51 of the driving magnet unit 50. In this embodiment, each of the sensors 61 of the sensor unit 60 is a Hall sensor that is operable so as to detect a magnetic field, and so as to generate an electrical signal, i.e., a voltage, that corresponds to the magnetic field detected thereby.

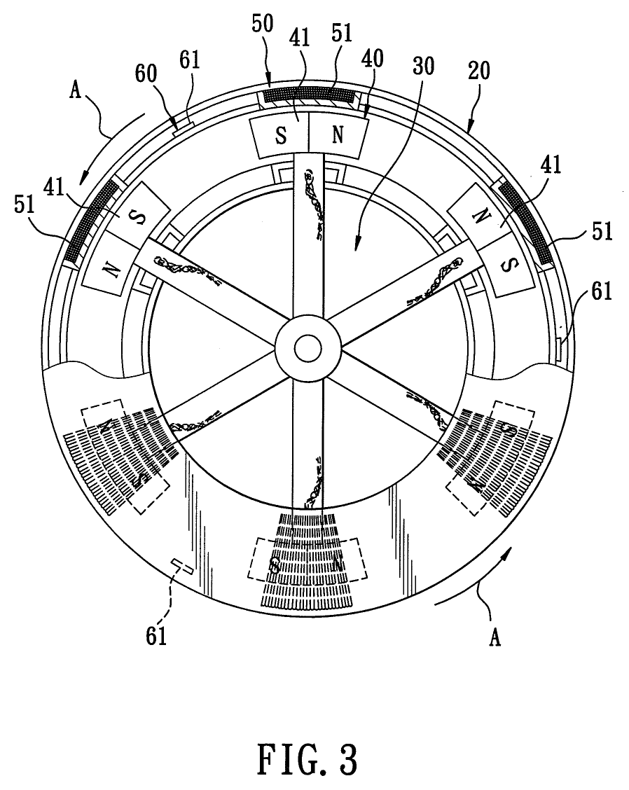

In operation, when the rotating member 30 is at the first angular orientation, as best shown in FIG. 1, three of the magnets 41 of the driven magnet unit 40 are respectively proximate to the sensors 61 of the sensor unit 60. At this time, each of the sensors 61 of the sensor unit 60 detects a magnetic field of a proximate one of the magnets 41 of the driven magnet unit 40, and generates an electrical signal that corresponds to the magnetic field detected thereby. In response to the electrical signal generated by each of the sensors 61 of the sensor unit 60, each of the magnets 51 of the driving magnet unit 50 generates a magnetic field such that each of the magnets 41 of the driven magnet unit 40 is repelled by one of the adjacent pair of the magnets 51 of the driving magnet unit 50 and is attracted by the other one of the adjacent pair of the magnets 51 of the driving magnet unit 50, thereby causing rotation of the rotating member 30 in a counter-clockwise direction, as indicated by arrow (A), to the second angular orientation. When the rotating member 30 is at the second angular orientation, as best shown in FIG. 3, each of the magnets 41 of the driven magnet unit 40 is substantially radially aligned with an adjacent one of the magnets 51 of the driving magnet unit 50. At this time, each of the sensors 61 of the sensor unit 60 detects changes in the magnetic field previously detected thereby, which results in disabling of each of the magnets 51 of the driving magnet unit 50 by the sensor unit 60 from generating the magnetic field, thereby permitting further rotation of the rotating member 30 to the first angular orientation by virtue of inertia.

From the above description, the motive force generating device of this invention, when compared to conventional electric motors built from stators and rotors, can be operated to cause continuous rotation of the rotating member 30 by enabling and disabling the driving magnet unit 50 based on angular orientation of the rotating member 30 relative to the driving magnet unit 50, thereby resulting in a simple, low cost, and highly energy efficient motive force generating structure suited for application to motor vehicles.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A motive force generating device, comprising:
a rotating member rotatable about an axis of rotation;
a driving magnet unit disposed at a position relative to said rotating member;
a driven magnet unit mounted on and co-rotatable with said rotating member; and
a sensor unit for causing one of said driving and driven magnet units to generate a magnetic field when said rotating member is at a first angular orientation relative to said driving magnet unit such that said driving and driven magnet units generate magnetic forces for causing rotation of said rotating member;
said sensor unit disabling said one of said driving and driven magnet units from generating the magnetic field when said rotating member is at a second angular orientation relative to said driving magnet unit, thereby permitting further rotation of said rotating member to the first angular orientation by virtue of inertia.

2. The motive force generating device as claimed in claim 1, wherein said sensor unit is operable to detect a magnetic field of said driven magnet unit when said rotating member is at the first angular orientation, and to generate an electrical signal that corresponds to the magnetic field detected thereby, said driving magnet unit generating the magnetic field in response to the electrical signal generated by said sensor unit.

3. The motive force generating device as claimed in claim 2, wherein said driving magnet unit is an electromagnet, and has a core axis lying on a plane transverse to the axis of rotation.

4. The motive force generating device as claimed in claim 2, wherein said driven magnet unit is a permanent magnet.

5. The motive force generating device as claimed in claim 2, wherein said driven magnet unit includes a plurality of angularly spaced apart magnets, one of which is proximate to the sensor unit when said rotating member is at the first angular orientation, said sensor unit detecting the magnetic field of said proximate one of said magnets of said driven magnet unit when said rotating member is at the first angular orientation.

6. The motive force generating device as claimed in claim 5, wherein said magnets of said driven magnet unit are arranged such that adjacent poles of two adjacent ones of said magnets of said driven magnet unit have the same polarity.

7. The motive force generating device as claimed in claim 5, wherein each of said magnets of said driven magnet unit is a permanent magnet.

8. The motive force generating device as claimed in claim 5, wherein said rotating member includes a hub, and angularly displaced spokes, each of which extends radially and outwardly from said hub, each of said magnets of said driven magnet unit being mounted on a respective one of said spokes of said rotating member.

9. The motive force generating device as claimed in claim 7, wherein said driving magnet unit includes a plurality of angularly spaced apart electromagnets, each of which has a core axis lying on a plane transverse to the axis of rotation.

10. The motive force generating device as claimed in claim 2, wherein said driving magnet unit includes a plurality of angularly spaced apart electromagnets, each of which has a core axis lying on a plane transverse to the axis of rotation.

11. The motive force generating device as claimed in claim 1, further comprising an annular housing, the center of which is at the axis of rotation, said rotating member extending rotatably into said annular housing, said driving magnet unit being mounted on said annular housing, said driven magnet unit being disposed in said annular housing.

12. The motive force generating device as claimed in claim 11, wherein said annular housing is formed with a hole that surrounds the axis of rotation, said rotating member extending into said annular housing through said hole.

13. The motive force generating device as claimed in claim 11, wherein said annular housing includes complementary upper and lower housing parts that cooperatively define an accommodating space, said rotating member extending rotatably into said accommodating space, said driven magnet unit being disposed in said accommodating space.
